(19) United States
(12) Patent Application Publication
(10) Pub. No.: US 2020/0280097 A1
(43) Pub. Date: Sep. 3, 2020

(54) HIGH-ENERGY DENSITY RECHARGEABLE LITHIUM BATTERY

(71) Applicant: University of Maryland, College Park, College Park, MD (US)

(72) Inventors: Long Chen, Greenbelt, MD (US); Xiulin Fan, College Park, MD (US); Chunsheng Wang, Silver Spring, MD (US)

(73) Assignee: University of Maryland, College Park, College Park, MD (US)

(21) Appl. No.: 16/805,323

(22) Filed: Feb. 28, 2020

Related U.S. Application Data
(60) Provisional application No. 62/811,982, filed on Feb. 28, 2019.

(51) Int. Cl. H01M 10/0567; H01M 10/0525; H01M 10/0568; H01M 10/0569; H01M 4/525; H01M 4/505

(52) U.S. Cl. CPC H01M 10/0567; H01M 10/0525; H01M 10/0568; H01M 2004/028; H01M 4/525; H01M 4/505; H01M 2300/0025; H01M 10/0569

(57) ABSTRACT

The present invention provides a high-energy density rechargeable lithium battery and method for making and using the same. In particular, the lithium batteries of the invention include a high potential cathode, an anode, and an electrolyte solution that comprises a fluorinated electrolyte, fluorinated solvent and a fluorinated additive. The lithium batteries of the invention have a cell that is at least 5 V when fully charged. Furthermore, the lithium battery of the invention has a high coulombic efficiency and can be recharged over 100 times while maintaining capacity retention of at least 90%.

### CROSS-REFERENCE TO RELATED APPLICATIONS

This application claims the priority benefit of U.S. Provisional Application No. 62/811,982 filed Feb. 28, 2019, which is incorporated herein by reference in its entirety.

### FIELD

The present invention relates to a high-energy density rechargeable lithium battery. In particular, the lithium batteries of the invention have a cell that is at least 5 V when fully charged. Furthermore, the lithium battery of the invention has a high coulombic efficiency and can be recharged over 100 times while maintaining capacity retention of at least 90%.

### BACKGROUND

Improving the energy density of batteries has been at the core of battery technology development. The progresses in basic science and engineering have driven the emergence of generations of batteries with increased energy density from Pb-acid to Ni—Cd and Ni-MH batteries and finally to the lithium battery. The advent of rechargeable lithium-ion battery (LIB) in 1990s is a milestone in science and technology history due to the remarkably enhanced energy density, low self-discharge and negligible memory effect, which in turn intensively stimulated the advances in portable electronic devices. Today, a higher energy density of rechargeable batteries is becoming much more desired due to inter alia the increasing demands from the coming 5G communication technology, internet of things (IoT), and electric vehicles (EV).

The energy density of lithium batteries can be enhanced among other means by increasing the specific capacity of the electrodes or by enhancing the cell voltage. After more than ten years of optimization of electrode materials, the energy density of intercalation chemistry cells with voltage of <=4.4 V have approached the limit due to the limited capacity of batteries with lithium transition metal oxide and phosphate cathodes and graphite anode materials, while the high energy cells with conversion chemistry (such as sulfur and fluorides) still suffer from less reversibility and poor cycle life. For example, sulfur cathodes have an extremely high capacity (1675 mAh g⁻¹) and a low cost and have been viewed as one of the most promising cathode candidates for next-generation batteries. However, the low volumetric energy density of the Li—S battery (˜200 Wh L⁻¹ vs. 600 Wh L⁻¹ for the commercial LiCoO₂ battery) and the serious shuttle reaction block the possible application for the electric vehicles. Alternatively, an increase in the cell voltage obtained by using a high-potential cathode paired with a low-potential Li metal or graphite anode can more effectively enhance the energy density of the lithium (ion) battery compared with the strategy of increasing the electrode capacity.

In recent years, several “high potential” cathodes with operation potential below 5.0 V have been extensively investigated. However, the average operation potentials of these “high potential” cathodes are still lower than 4.5 V. Even for the so-called “5.0 V cathode materials”, such as LiNi_{0.5}Mn_{1.5}O₄ and LiCoPO₄, their operation potentials are still only 4.7 V and 4.8 V vs. Li⁺/Li, respectively. More problematically, no conventional electrolytes can sustain these 4.8 V cathodes for a long cycle life. Very recently, a highly concentrated electrolyte enabled a successful 150 cycles of LiNi_{0.5}Mn_{1.5}O₄. Unfortunately, current electrolytes suffer severe decomposition on these cathode surfaces when the cathodes are fully charged to a potential above 4.5 V. While numerous programs like Battery 500/600 targeting at improving the cell energy density through innovative technologies have been conducted or proposed worldwide, no practical solution has yet been achieved to date for commercially useful highly reversible >5.0 V lithium batteries.

Accordingly, there is a continuing need for achieving high-energy density rechargeable lithium batteries having 5 V or more.

### SUMMARY

Some aspects of the present invention are based on the discovery by the present inventors of a stable electrolyte solution that allows high-energy density battery with a significant reduction in decomposition on cathode surfaces relative to conventional electrolyte. In particular, the present inventors have found that adding a fluoride-based additive to an electrolyte solution provides a significant increase in energy density while avoiding decomposition observed in conventional electrolytes.

In one particular aspect of the invention, an electrolyte solution for a rechargeable lithium battery is provided. The electrolyte solution comprises a fluorinated solvent, an inorganic fluoride salt as an electrolyte, and an electrolyte additive comprising lithium difluoro(oxalate)borate, lithium bis(oxalato)borate, 1,3,2-Dioxathiolane 2,2-dioxide, or a combination thereof. In one particular embodiment, the electrolyte additive comprises lithium difluoro(oxalate)borate (“LiDFOB”). In some embodiments, the fluorinated solvent comprises fluoroethylene carbonate (“FEC”), bis(2,2,2-trifluoroethyl) carbonate (“FDEC”), hydrofluoroether (“HFE”), 3,3,3-fluoroethylmethyl carbonate (FEMC); trifluoropropylene carbonate (TFPC); 3-Fluoropropyl hexafluoroisopropyl carbonate; tert-Butyl 3,3,3-trifluoro-2,2-dimethylpropyl carbonate; Bis(3,3,3-trifluoro-2,2-dimethylpropyl) carbonate; Isopropyl 3,3,3-trifluoro-2,2-dimethylpropyl carbonate; sec-Butyl 3,3,3-trifluoro-2,2-dimethylpropyl carbonate; Butyl 3,3,3-trifluoro-2,2-dimethylpropyl carbonate; Propyl 3,3,3-trifluoro-2,2-dimethylpropyl carbonate; Ethyl 3,3,3-trifluoro-2,2-dimethylpropyl carbonate; Methyl 3,3,3-trifluoro-2,2-dimethylpropyl carbonate; 3-Fluoropropyl 2,2,2-trifluoroethyl carbonate; 2,2-Difluoroethyl 3-fluoropropyl carbonate, or a mixture thereof.

In one particular embodiment, the fluorinated solvent comprises a mixture of FEC, FDEC, and HFE. The amount of FDEC relative to the amount of FEC can ranges from about 0.5 to about 10, typically from about 1 to about 10, often from about 1 to about 5, and most often from about greater than 1 to about 3 equivalents by volume. When referring to a numerical value, the term “about” or “approximately” are used interchangeably herein and refer to being within an acceptable error range for the particular value as determined by one of ordinary skill in the art. Such a value determination will depend at least in part on how the value is measured or determined, e.g., the limitations of the measurement system, i.e., the degree of precision required for a particular purpose. For example, the term “about” can mean within 1 or more than 1 standard deviation, per the practice in the art. Alternatively, the term “about” when referring to a numerical value can mean±20%, typically ±10%, often ±5% and more often ±1% of the numerical value. Generally, however, where particular values are described in the application and claims, unless otherwise stated, the term “about” means within an acceptable error range for the particular value, typically within one standard deviation.

In another embodiment, the amount of HFE relative to the amount of FEC ranges from about 0.25 to about 5, typically from about 0.5 to about 5, often from about 0.5 to about 2, and most often from greater than 0.5 to about 1.5 equivalents by volume.

Still in another embodiment, the inorganic fluoride salt electrolyte comprises lithium hexafluorophosphate. Typically, the concentration of lithium hexafluorophosphate in the fluorinated solvent ranges from about 0.1 M to about 5 M, often from about 0.5 M to about 3 M, more often from about 0.5 M to about 2 M, and most often from greater than about 0.5 M to about 1.5 M. In one specific embodiment, the concentration of lithium hexafluorophosphate is about 1 M.

Yet in other embodiments, the concentration of LiDFOB in the fluorinated solvent ranges from about 0.001 M to less than 1 M, typically from about 0.005 M to about 0.5 M, often from about 0.01 M to about 0.25 M, and most often from about 0.05 M to about 0.1 M. In one specific embodiment, the concentration of LiDFOB in the fluorinated solvent is about 0.02 M.

In another embodiment, the amount of LiDFOB relative to the amount of lithium hexafluorophosphate ranges from about 0.1 to about 1 equivalent, typically from about 0.1 to less than 1 equivalents, often from about 0.1 to about 0.5 equivalents, and more often from about 0.1 to about 0.3 equivalents.

Other aspects of the invention are based on the new high capacity cathode discovered by the present inventors. In one particular embodiment, the cathode of the invention is substantially Mn⁺³ free LiCoMnO₄ cathode. As used herein, the term “substantially Mn⁺³ free” means about 10% or less, typically about 5% or less, often about 2% or less, more often about 1% or less, still more often about 0.1% or less, and most often about 0.01% or less of Mn⁺³. In one specific embodiment, LiCoMnO₄ is a spinel structured LiCoMnO₄.

Still other aspects of the invention provide a high-energy density rechargeable lithium battery having a cell of at least 5 V. The lithium battery comprises: (i) a high potential cathode; (ii) an anode; and (iii) a fluorinated electrolyte solution comprising a fluoride-based additive, wherein said fluorinated electrolyte solution is stable to at least about 5 V.

In one embodiment, the anode comprises lithium metal, graphite, silicon, Li₄Ti₅O₁₂, or a combination thereof.

Still in another embodiment, the high potential cathode comprises LiCoMnO₄, LiCoPO₄F, LiCu_{0.5}Mn_{1.5}O₄, LiNi_{0.5}Mn_{1.5}O₄, LiFe_{0.5}Mn_{1.5}O₄, LiCOPO₄, or a combination thereof. In one specific embodiment, the cathode comprises LiCoMnO₄. In other embodiments, LiCoMnO₄ is a spinel structured LiCoMnO₄. In another particular embodiment, LiCoMnO₄ is substantially Mn⁺³ free.

Yet in other embodiments, the lithium batteries of the invention have capacity retention of at least about 70%, typically at least about 75%, often at least about 80%, more often at least about 85%, and most often at least about 90% after 1,0000 cycles. The term “life cycle” when referring to a battery is defined as a total number of recharging while still maintaining coulombic efficiency of at least 99%, typically at least 99.5%, and often at least 99.9%. Alternatively, the term “life cycle” refers to the number of total cycle that the battery is recharged before having its capacity drop or fall below about 80%, typically about 85%, and often about 90% of its theoretical capacity. The term “cycle” when referring to a battery means a recharging of the battery, typically recharging from about 5% or less charge to at least about 90% charge. Thus, one skilled in the art can readily determine the “life cycle” of a battery by allowing the battery's charge to deplete to about 5% or less of the theoretical charge and recharging the battery to at least about 90% of the theoretical charge, and repeating the process until either the coulombic efficiency of the capacity of the battery falls below the amount as defined herein.

Still yet in other embodiments, the lithium battery of the invention has capacity retention of at least about 80%, typically at least about 85%, often at least about 90%, and more often at least about 95% after 100 cycles.

In other embodiments, the lithium battery of the invention has coulombic efficiency of at least about 80%, typically at least about 85%, often at least about 90%, more often at least 95%, and most often at least about 98%. Still in other embodiments, the lithium battery of the invention has coulombic efficiency of at least 99%, typically at least 99.5%, and often at least 99.9%.

In further embodiments, the lithium battery of the invention has energy density of at least about 400 Wh kg⁻¹, typically at least about 450 Wh kg⁻¹, often at least about 500 Wh more often at least about 600 Wh kg⁻¹, and most often at least about 700 Wh kg⁻¹. It should be appreciated that the scope of the invention is not limited to these particular energy densities. In fact, the energy density of a particular battery of the invention depends on a variety of factors such as, but not limited to, the cathode material, the anode material, the electrolyte solution, and the nature of the additive material used.

Other aspects of the invention provide a method for producing and using the electrolyte solution, the high capacity cathode, and/or the battery disclosed herein.

### BRIEF DESCRIPTION OF THE DRAWINGS

FIG. 1A shows crystal structure (inset) and X-ray diffraction patterns with Rietveld refinement of LiCoMnO₄ that is prepared in accordance with the procedure disclosed herein. Weight percent fractions from structural refinements are as follows: 93% LiCoMnO₄ and 7% Li₂MnO₃.

FIG. 1B is a graph showing excerpt of data from 2.1° to 2.6° in 2θ, the subscripts (c and m) to (hkl) represent different phase: “c” represent cubic; “m” represent monoclinic.

FIG. 1C is a graph showing excerpt of data from 3.45° to 4.05° in 2θ.

FIG. 2 is SEM images of LiCoMnO₄ that is prepared in accordance with the procedure disclosed herein. Scanning electron microscopy (SEM) images of as prepared LiCoMnO₄ show that its primary particle size is about 100-200 nm, which connect with each other to form micro size second particles around 8 μm. The morphology of this as prepared LiCoMnO₄ sample is similar with its precursor CoMnO_{X}. This nano-particle size enable a good rate performance.

FIG. 3 shows HRTEM and HR-HAADF-STEM results of LiCoMnO₄ that is prepared in accordance with the procedure disclosed herein. Panel A is a high-resolution TEM image of the whole particle; Panels (B) and (C) are high-resolution TEM image of the LiCoMnO₄ surface region (dash regions in (A)), fast Fourier transform (FFT) patterns in the insets show the [110] zone axis of a spinel structure; Panel (D) is HAADF-STEM image of the whole particle; Panels (E) and (F) show HR-HAADF-STEM images of the select region of LiCoMnO₄, (dash regions in (D)), the inset shows the atomic model of the transition metal atom (Co or Mn) along [110] zone axis.

FIG. 4 shows HAADF-STEM and STEM-EELS mappings results of LiCoMnO₄ that is prepared in accordance with the procedure described herein. In FIG. 4, panel (A) is HAADF-STEM image of the whole particle; panels (B)-(E) show STEM-EELS mappings of the select region of particle (white dash region in (A)); and panel (F) is HAADF-STEM images of the select region (red dash region in (A)), fast Fourier transformation (FFT) pattern in the inset shows the [2-12] zone axis of LiMnO₃ phase, and the red ball symbolize the transition metal atom.

FIG. 5 shows graphs of linear sweep voltammograms of different electrolyte solutions. Panel A shows potential ranging from <3 V to up to 6 V, whereas panel B shows potential ranging from 0 V to 3 V.

FIG. 6A is a graph of galvanostatic charge-discharge profile of the LiCoMnO₄ at the current rate of 0.1 A g⁻¹ (calculated based on the activated material) between 3-5.3 V. The inset is the first two cyclic voltammetry (CV) curves of LiCoMnO₄, the scan rate was 0.3 mV s⁻¹, and the voltage window is 3-5.5 V.

FIG. 6B is a graph of the discharge profiles and energy densities of several high voltage cathode materials (LiCoMnO₄, LiCoPO₄, LiNi_{0.5}Mn_{1.5}O₄, LiCoO₂, NCM 622 (LiNi_{0.6}Co_{0.2}Mn_{0.2}O₂)), the current rate was 0.1 A g⁻¹ (calculated based on the activated material).

FIG. 6C is a graph of first galvanostatic charge/discharge profile of LiCoMnO₄ that was prepared according to the procedure disclosed herein at the current rate of 0.02 A g⁻¹ within the voltage window of 3-5.3 V. The regions a-g correspond to different charge/discharge states of LiCoMnO₄ for XANES and EXAFS tests, a: pristine; b, 4.9 V; c, 5.2 V; d, 5.3 V; e, 5.1 V; f, 4.5 V; g, 3.0 V.

FIG. 6D is a Co K-edge XANES spectra of LiCoMnO₄ in different charge and discharge states.

FIG. 6E is a Mn K-edge XANES spectra of LiCoMnO₄ in different charge and discharge states.

FIG. 6F shows Fourier transform of k³-weighted EXAFS patterns for Co K-edge of LiCoMnO₄ in different charge and discharge states.

FIG. 6G shows Fourier transform of k³-weighted EXAFS patterns for Mn K-edge of LiCoMnO₄ in different charge and discharge states.

FIGS. 7A and 7B are graphs showing galvanostatic charge/discharge profiles and linear sweep voltammogram, respectively, of LiCoMnO₄ that was prepared in accordance with the procedure disclosed herein in 1 M LiPF₆ EC/DMC.

FIG. 8 is the selected regions of in situ XRD patterns of LiCoMnO₄ of the present invention collected during the charge/discharge cycles. The operando cell was charged and discharged between 5.3 V and 3.0 V at a current rate of C/5.

FIG. 9 A shows voltage profiles for the Li metal plating/stripping on a Cu working electrode cycled in an electrolyte solution of the present invention (e.g., 1 M LiPF₆+0.02 M LiDFOB in FEC/FDEC/HFE) at a current density of 0.5 mA cm⁻².

FIG. 9B shows coulombic efficiency for the Li plating/stripping cycled in an electrolyte solution of the present invention (e.g., 1 M LiPF₆+0.02 M LiDFOB in FEC/FDEC/HFE) at the current of 0.5 mA cm⁻².

FIG. 9C shows cycle performance and coulombic efficiency of the Li∥LiCoMnO₄ cell with an electrolyte solution of the present invention (1 M LiPF₆+0.02 M LiDFOB in FEC/FDEC/HFE) and FEC based electrolyte (1 M LiPF₆ FEC/DMC) at the current rate of 0.1 A g⁻¹ (calculated based on the cathode activated material) between 3-5.3 V.

FIG. 9D shows cycle performance of the Li∥LiCoMnO₄ cell with the electrolyte solution of the present invention (e.g., 1 M LiPF₆+0.02 M LiDFOB in FEC/FDEC/HFE) at the current rate of 1 A g⁻¹ (calculated based on the cathode activated material) between 3-5.3 V.

FIG. 10 shows galvanostatic charge/discharge profiles of LiCoMnO₄ that was prepared using the procedure disclosed herein with different cycles in 1 M LiPF₆ FEC/DMC. The current rate is 0.1 A g⁻¹ which is calculated based on the activated material, the voltage window is from 3 to 5.3 V.

FIG. 11A shows galvanostatic charge-discharge profiles of the graphite with different cycles at the current density of 0.1 A g⁻¹ (calculated based on the activated material) between 0-1.5 V in one particular electrolyte solution of the present invention.

FIG. 11B is a typical galvanostatic charge-discharge profile of the graphite∥LiCoMnO₄ full cell at the current rate of 1 C (one hour for the charge or discharge process) with one particular electrolyte solution of the present invention within the voltage window of 3-5.3 V.

FIG. 11C shows cycle performance of the graphite at the current density of 0.1 A g⁻¹ (calculated based on the activated material) between 0-1.5 V in one particular embodiment of an electrolyte solution of the present invention.

FIG. 11D shows cycle performance of the graphite∥LiCoMnO₄ full cell at the current rate of 1 C (one hour for the charge or discharge process) with one particular electrolyte solution of the present invention within the voltage window of 3-5.3 V.

### DETAILED DESCRIPTION

Some aspects of the invention provide rechargeable high-energy density lithium batteries. In some embodiments, the high-energy density lithium batteries of the invention comprise a LiCoMnO₄ cathode.

Typically, spinel structured LiCoMnO₄ has a high lithiation/delithiation plateau potential of 5.3 V with a theoretical specific capacity of 145 mAh g⁻¹. However, no electrolytes can sustain such a high voltage (>5.3 V), although significant efforts have been devoted in the past decades to exploring high voltage Li-ion electrolytes by using highly stable solvents and functional additives. Prior to the discovery by the present inventors, the best electrolytes only allow LiCoMnO₄ to be partially lithiated/delithiated up to 75% of the theoretical capacity (i.e., <110 mAh/g). More significantly, the decomposition of the electrolytes typically resulted in a very low coulombic efficiency (<80%), often limiting the life cycle of LiCoMnO₄ cathode to less than 100 cycles. Furthermore, most of the conventional high voltage electrolytes with high oxidation tolerance, such as sulfone- and organic nitrile-based electrolytes, typically suffer from poor reductive stability due to the formation of an unstable SEI on anodes, resulting in poor cycling stability and a low coulombic efficiency for graphite and Li anodes. These high-voltage electrolytes are seldom used in Li-ion or Li-metal batteries. In addition, almost all of the previously reported LiCoMnO₄ contains Mn³⁺ ions inside the spinel lattice LiCo³⁺Mn⁴⁺O₄. Without being bound by any theory, it is believed that the replacement of Co³⁺ by Mn³⁺ results in a voltage plateau at 4.0 V, which significantly reduces the energy density.

In some embodiments, rechargeable batteries of the invention comprise a combination of a high potential LiCo³⁺Mn⁴⁺O₄ cathode with a low potential anode such as, for example, Li metal anode and/or graphite anode. As used herein, the term “rechargeable” refers to batteries that are capable of being recharged at least about 100 cycles, typically at least about 500 cycles, and often at least about 1,000 cycles while maintaining charge capacity of at least about 80%, often at least about 90% theoretical charge capacity. In some embodiments, batteries of the invention have LiCo³⁺Mn⁴⁺O₄ cathode that is substantially free of Mn⁺³ ion.

Still in other embodiments, batteries of the invention have potential difference between the cathode and the anode of at least about 5.0 V, typically at least about 5.1 V, often at least about 5.2 V, and most often at least about 5.3 V. It should be appreciated that the potential difference depends on a variety of factors such as the type of cathode, anode, and/or electrolyte used.

Yet in other embodiments, coulombic efficiency of batteries of the invention is at least about 80%, typically at least about 85%, often at least about 90%, more often at least about 95%, and most often at least about 98%.

Additional objects, advantages, and novel features of this invention will become apparent to those skilled in the art upon examination of the following examples thereof, which are not intended to be limiting. In the Examples, procedures that are constructively reduced to practice are described in the present tense, and procedures that have been carried out in the laboratory are set forth in the past tense.

### Examples

Synthesis and Characterization of LiCoMnO₄.

The LiCoMnO₄ was synthesized by a two-step method. Briefly, the first step was the synthesis of MnCoOₓ. To a solution of 2.1 mmol of CoCl₂.6H₂O and 1.75 mmol of MnCl₂.4H₂O in 66 ml of distilled water was added 2.46 g of urea, 2.5 g of ascorbic acid, and 2 g of polyvinylpyrrolidone (PVP, MW˜40K). The reaction mixture was stirred for 1 h., and then transferred to a 100 ml Teflon-lined stainless steel autoclave and maintained at 160° C. for 6 h. The CoMnCO₃ microspheres were obtained, washed with water and ethanol for several times, and dried at 60° C. overnight. The resulting CoMnCO₃ microspheres was calcinated in air at 400° C. for 5 h to obtain CoMnOₓ microspheres. Thereafter, a mixture of 0.7 g of CoMnOₓ and 0.165 g of Li₂CO₃ were calcinated at 800° C. for 24 h in 02 atmosphere to obtain LiCoMnO₄ product.

Characterization.

Ex-situ and in-situ XRD experiment was performed at 28-ID-2 beamline of the National Synchrotron Light Source II (NSLS II) at Brookhaven National Laboratory (BNL) using a Perkin Elmer amorphous-Si flat panel detector. For in-situ XRD, the in-situ cell was made by assembling active material, carbon black and PTFE binder into a pouch cell with active material loading of 8 mg/cm². The pouch cell was then sandwiched by two metallic plates with carbon window in the center which guarantees the pressure on the cell. Collected raw image data was then integrated to yield the 2theta-intensity XRD pattern using software Fit2D. The Rietveld refinement was carried out using GSAS-EXPGUI software.

The morphologies of the sample were examined using a Hitachi a SU-70 field-emission scanning electron microscope (SEM) and JEOL 2100F field emission transmission electron microscope (TEM). HRTEM and HAADF-STEM measurements were performed using a JEOL 2010F transmission electron microscope (TEM) operating at accelerating voltage of 200 kV. The high-angle-annular-dark-field (HAADF) scanning transmission electron microscopy (STEM) and STEM electron-energy-loss-spectroscopy (EELS) were performed with an aberration corrected Hitachi HD 2700C STEM at 200 kV in Brookhaven National Lab. The conversion angle and collection angles for STEM imaging are 22 mrad and 64-341 mrad respectively.

The surface chemistry of the electrodes after cycling was examined by X-ray photoelectron spectroscopy (XPS) using a Kratos Axis 165 spectrometer. The electrodes were then taken out from the cell after 100 cycles, and rinsed by dimethyl carbonate (DMC) inside the glove box for three times. All samples were dried under vacuum overnight, placed in a sealed bag, and then transferred into the XPS chamber under inert conditions in an Argon-filled glove bag. XPS data were collected using a monochromated Al Kα X-ray source (1486.7 eV). The working pressure of the chamber was lower than 6.6×10⁻⁹ Pa. All reported binding energy values are calibrated to the C 1 s peak at 284.8 eV.

X-ray absorption spectroscopy (XAS) measurements were performed at 12 BM beamline of the Advanced Photon Sources (APS) at Argonne National Laboratory (ANL) in the transmission mode. The X-ray absorption near edge structure (XANES) and Extended X-ray absorption fine structure (EXAFS) spectra were processed using the Athena software package. The AUTOBK code was used to normalize the absorption coefficient, and separate the EXAFS signal, χ(k), from the isolate atom-absorption background. The extracted EXAFS signal, χ(k), was weighted by k³ to emphasize the high-energy oscillations and then Fourier-transformed in a k range from 3.0 to 13.5 Å⁻¹ to analyze the data in R space.

Electrochemical Measurements.

To prepare the working electrode, the as-synthesized LiCoMnO₄ and other commercial cathode (LiCoPO₄, LiNi_{0.5}Mn_{1.5}O₄), and anode materials (graphite, MCMB purchased from MTI) were mixed with carbon black, and PVDF with a mass ratio 80:10:10 into homogeneous slurry in NMP with pestle and mortar. The slurry mixture was coated onto Al or Cu foil and then dried at 100° C. for 12 h. The loading mass of the active materials for the electrode was about 1 mg/cm². The all fluorinated electrolyte solution comprised of 1 M LiPF₆ in fluoroethylene carbonate (FEC)/bis(2,2,2-trifluoroethyl) carbonate (FDEC)/hydrofluoroether (HFE) (2:6:2 by volume), with different amount of additives (without, with 0.02M, with 0.05M lithium difluoro(oxalato)borate, LiDFOB). The conventional electrolyte solution comprised of 1M LiPF₆ in ethylene carbonate (EC)/dimethyl carbonate (DMC) (1:1 by volume). The FEC based electrolyte solution comprised of 1M LiPF₆ in fluoroethylene carbonate (FEC)/dimethyl carbonate (DMC) (2:8 by volume). The cells were assembled with a polypropylene (PP) microporous film (Celgard 3501) as the separator. The electrochemical tests were performed using a coin-type half cell (CR 2016), which is fabricated in a glove box filled with Argon. Electrochemical performance was tested using Arbin battery test station (BT2000, Arbin Instruments, USA).

Results and Discussion:

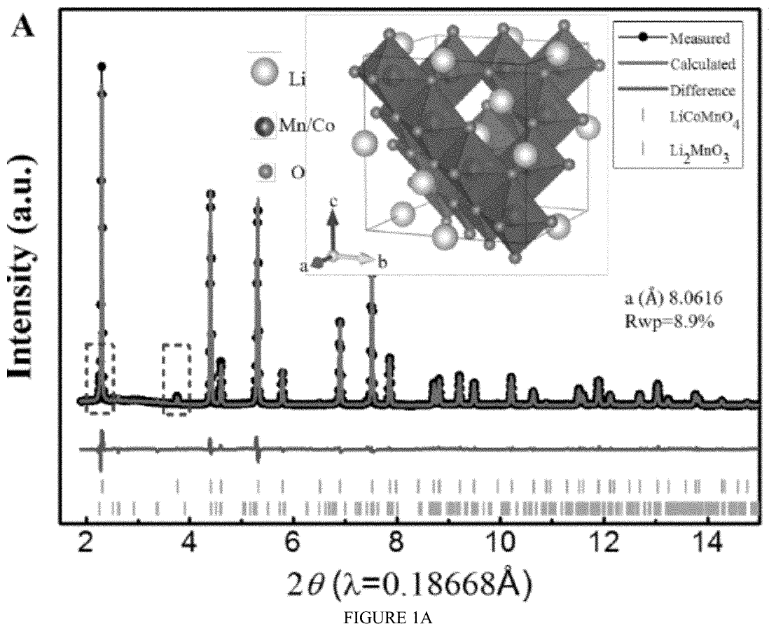

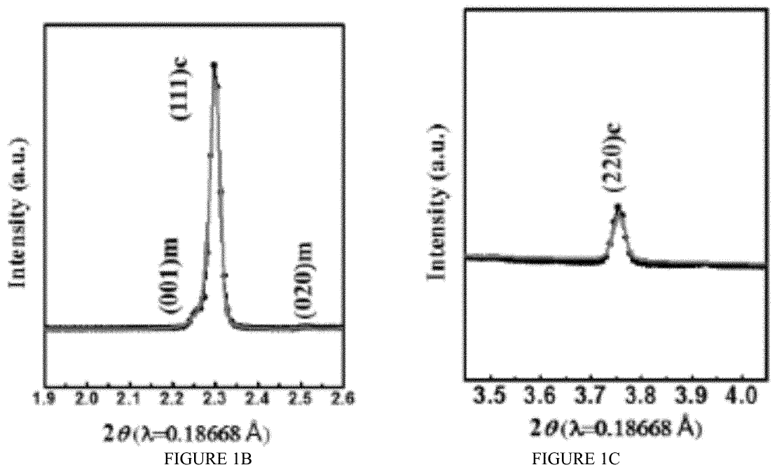

The X-ray diffraction patterns of LiCoMnO₄ prepared in accordance with the procedure described herein reveal the cubic Fd3̅m spinel structure (FIG. 1A). Detailed structural information of LiCoMnO₄ is shown in Table 1 below and illustrated in the inset of FIG. 1A. Generally, it shows typical spinel structure with the space group of Fd3̅m. Cubic closed-packed oxygen anions consist of the sub-lattice in which transition metals occupy octahedral 16d site and Li occupies tetrahedral 8a site. In this framework, lithium ions can be extracted and inserted reversibly through three-dimensional pathways made by the interconnected 8a tetrahedral sites and vacant 16c octahedral sites. The relatively strong (220) peak indicates some transition metal occupation at the tetrahedral 8a site (FIG. 1C) and the occupancy was quantitatively determined to be around 8% by Rietveld refinement. The small peaks at 2.25° and 2.52° are identified to be (001) and (020) of Li₂MnO₃, respectively (FIGS. 1A and 1B). Quantitative phase analysis by Rietveld refinement indicated that 7 wt % of Li₂MnO₃ exists in the LiCoMnO₄.

TABLE 1
Detailed structure data of LiCoMnO₄.
Space group: F d 3̅ m. a = 8.0616 (2) Å

| Atom | x | y | z | Occupancy | Uᵢₛₒ | |
|---|---|---|---|---|---|---|
| Li | 0.125 | 0.125 | 0.125 | 0.92 (1) | 0.003 | (2) |
| Co | 0.125 | 0.125 | 0.125 | 0.08 (1) | 0.003 | (2) |
| Li | 0.5 | 0.5 | 0.5 | 0.08 (1) | 0.0021 | (1) |
| Co | 0.5 | 0.5 | 0.5 | 0.42 (1) | 0.0021 | (1) |
| Mn | 0.5 | 0.5 | 0.5 | 0.5 | 0.0021 | (1) |
| O | 0.2618 (3) | 0.2618 (3) | 0.2618 (3) | 1 | 0.009 | (1) |

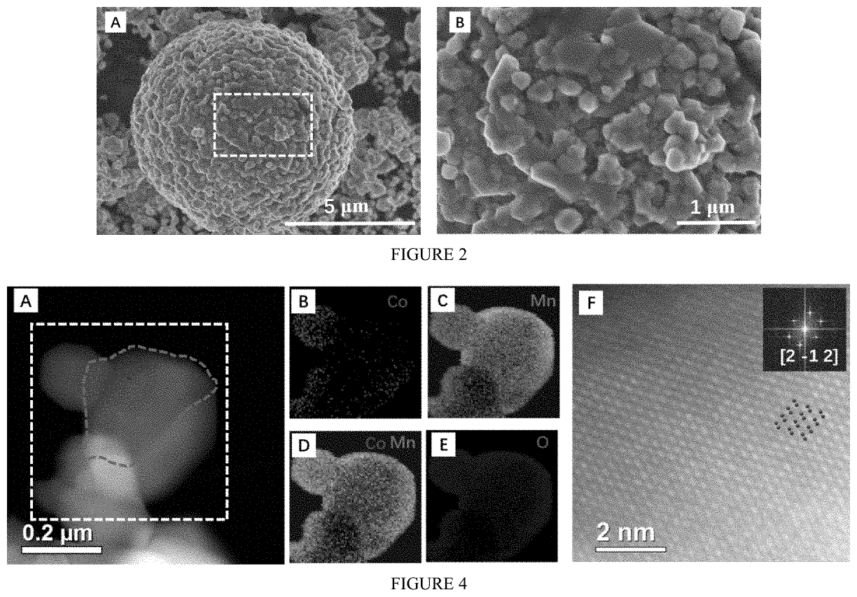

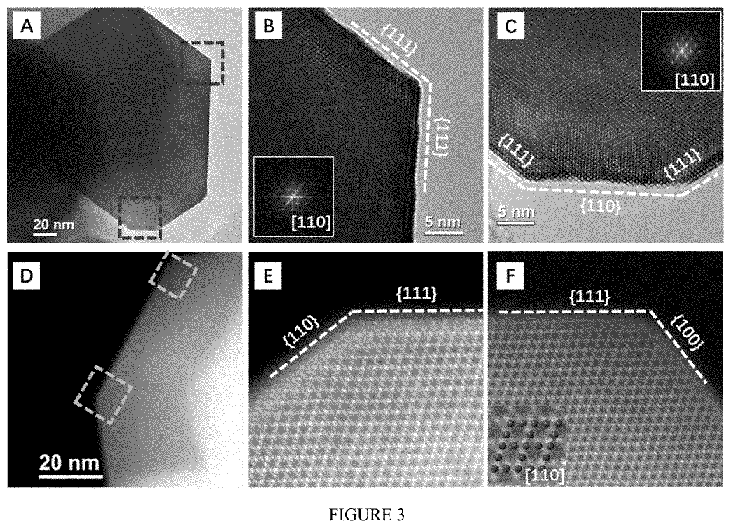

Scanning electron microscopy (SEM) images shows that LiCoMnO₄ particles have sphere morphology with particle size around 5 μm, which is aggregated by the primary LiCoMnO₄ particles with size of 100-200 nm (FIG. 2). Co, Mn, and O elements are homogeneously distributed in LiCoMnO₄ as demonstrated by the elemental mapping (not shown). High-resolution transmission electron microscopy (HRTEM) and the high-resolution high angle annular dark-field scanning transmission electron microscopy (HAADF-STEM) results (FIG. 3) further reveal the crystalline structure of the LiCoMnO₄ spinel oxide. Along the [110] zone axis, it can be determined that {100}, {110} and {111} facets are presented. In addition, in the HAADF-STEM images in FIG. 4, the existence of small amount of Li₂MnO₃ phase is also be identified in the red dash region, which is in line with the XRD results in FIG. 1A. According to the scanning transmission electron microscopy-electron energy loss spectroscopy (STEM-EELS) mapping images (FIGS. 4B-E), the blue dash region is an indication of the Li₂MnO₃ phase, and the other part is LiCoMnO₄ phase, therefore, two phases of LiCoMnO₄ and Li₂MnO₃ coexist in a single particle.

Electrochemical Behavior and Reaction Mechanism of LiCoMnO₄ Synthesized Using a Two-Step Method:

It should be noted that the lithiation/delithiation plateau potential of LiCoMnO₄ is theoretically as high as 5.3 V. Unfortunately, however, no conventional electrolyte could sustain such condition for extended time even when highly stable solvents or functional additives are used. In fact, conventional electrolytes suffer severe decomposition on the surface of high voltage cathodes when charged to a potential above 4.5 V.

Prior to the present invention, the best electrolytes only allow LiCoMnO₄ to be partially lithiated/delithiated up to 69% of the theoretical capacity (<100 mAh/g). The decomposition of the conventional electrolytes results in a dramatically poor Coulombic efficiency (<80%), limiting the cycling life of LiCoMnO₄ to less than 100 cycles. Moreover, most of conventional high voltage electrolytes with high oxidation-tolerance, such as sulfone and organic nitriles based electrolytes, suffer from poor reductive stability due to formation of unstable SEI on anodes, resulting in a poor cycling stability and a low Coulombic efficiency especially for graphite and Li anodes.

In contrast, electrolytes of the present invention provide a wide electrochemical stability that are stable to LiCoMnO₄ cathode as well as Li metal or graphite anodes. This stability allowed the present inventors to investigate the lithiation/delithiation mechanism of LiCoMnO₄, and to achieve high-performance Li∥LiCoMnO₄ and graphite∥LiCoMnO₄ cells.

The fluorinated solvents have higher oxidation potentials due to the strong electron-withdrawing effect of the fluorine atom. In addition, it is believed that LiF is a good electronic insulator that can block the electron leakage through the SEI, thereby preventing the continuous electrolyte consumption. LiF is also known to exhibit a high interfacial energy to Li metal, which facilitates Li⁺ transport along the interface and promotes the growth of the deposited Li metal in parallel rather than vertical direction with regard to the Li-metal plane. These features increase the cycle stability of Li metal. Moreover, additives used in the present invention further enhance the stability of the interphase film of both cathode and anode.

In one particular embodiment, the electrolyte solution of the invention is an all fluorinated electrolyte (e.g., 1 M LiPF₆ in FEC/FDEC/HFE) with an electrolyte additive comprising lithium difluoro(oxalate)borate, lithium bis(oxalato)borate, 1,3,2-Dioxathiolane 2,2-dioxide, or a combination thereof. In one particular embodiment, the additive comprises lithium difluoro(oxalate)borate (LiDFOB).

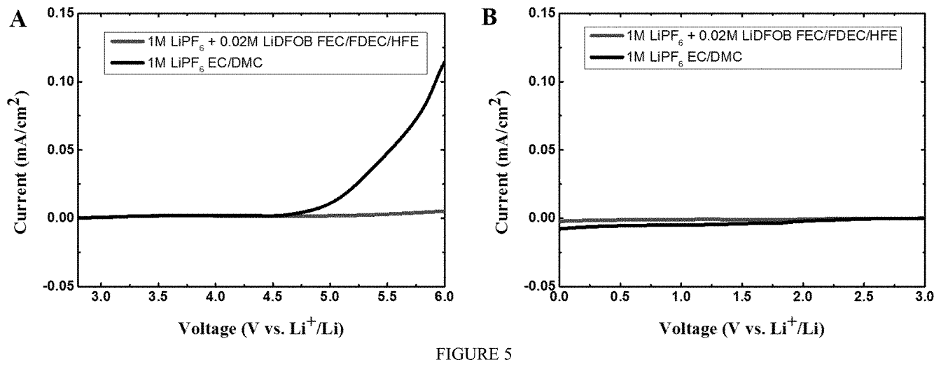

The electrochemical stability of the electrolyte solution of the invention was first evaluated using a linear sweep voltammogram (LSV) at a slow scan rate of 0.3 mV/s, and compared to LSV curves of conventional carbonate electrolyte (e.g., 1 M LiPF₆ in EC/DMC) curves at the same scan rate. As shown in panel A of FIG. 5, the oxidation current of the electrolyte solution of the present invention during anodic scan is very small up to 6.0V versus Li⁺/Li, while a rapid increase in oxidation current is observed for conventional carbonate electrolyte at potential above 4.6 V. In addition, the electrolyte solution of the present invention also shows much higher stability for reduction reaction than conventional carbonate electrolyte as shown in panel B of FIG. 5. In FIG. 5, three-electrode cell was us to measure the current with stainless steel (disc with a diameter of 0.95 cm) as working electrode and the same diameter Li foil as reference and counter electrode, the scanning rate was 0.3 mV s⁻¹. It can be seen that the carbonate-based conventional electrolyte is prone to oxidation at a lower voltage of about 4.5 V. In contrast, electrolyte solution of the present invention (e.g., 1 M LiPF₆+0.02 M LiDFOB in FEC/FDEC/HFE) is stable even at potential of 6.0 V at the low scan rate of 0.3 mV s⁻¹. In fact, FIG. 5, panel A, shows there is hardly any oxidation peak at a high potential (e.g., >4.6 V) compared to the conventional carbonate based electrolyte solution. Moreover, as shown in FIG. 5, panel B, the electrolyte solution of the present invention is also stable for Li metal near the 0 V.

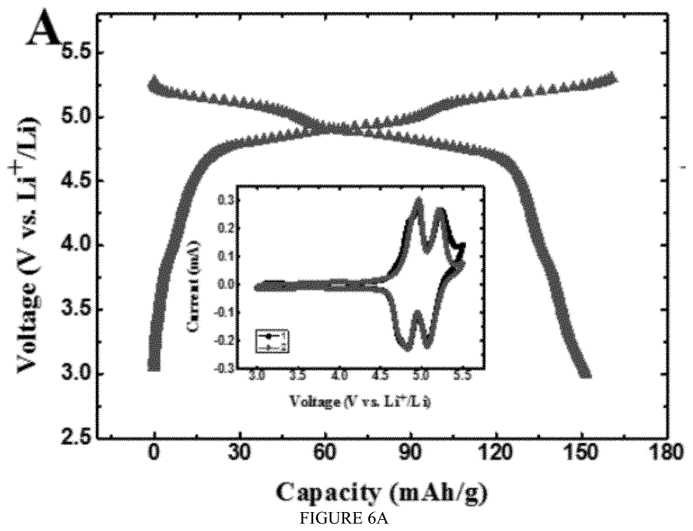

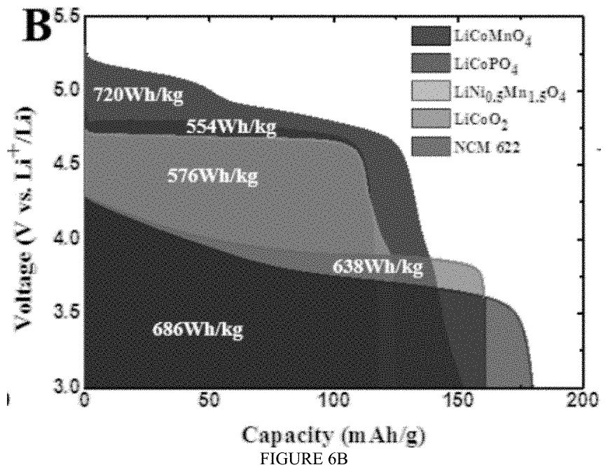

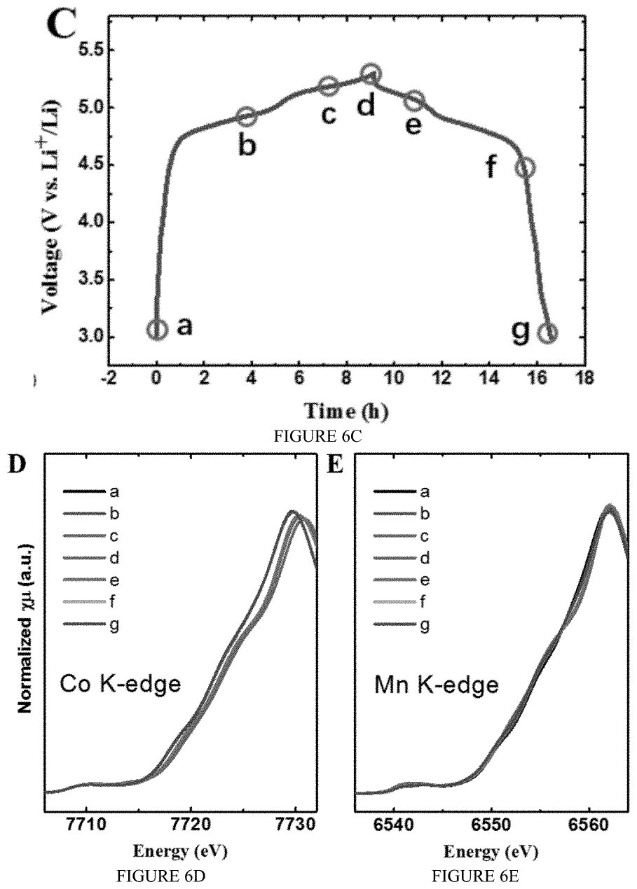

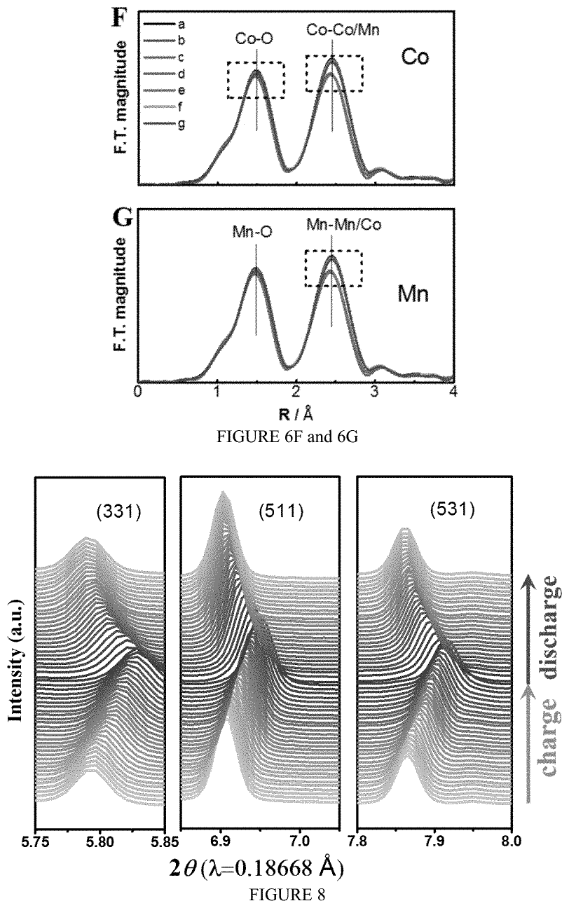

Galvanostatic charge/discharge profiles of LiCoMnO₄ in the electrolyte solution of the invention were then obtained. As shown in FIG. 6A two plateaus can be seen upon charging and discharging profiles at around 5.0-5.3 V and 4.7-4.9 V. The characteristic plateau at 4.0 V due to Mn³⁺ was almost undetectable, which is in sharp contrast to the LiCoMnO₄ synthesized using the conventional solid state reactions where a long 4.0 V plateau is always observed. The elimination of 4.0 V plateau is also confirmed by the cyclic voltammetry (CV) (inset in FIG. 6A). LiCoMnO₄ in the 5.6 V electrolyte solution of the present invention delivers a reversible specific capacity of 152 mAh g⁻¹, which is even higher than the theoretical specific capacity of LiCoMnO₄ (145 mAh g⁻¹).

Without being bound by any theory, it is believed that the presence of 7% of Li₂MnO₃ in LiCoMnO₄ particle is responsible for the extra capacity. The embedded Li₂MnO₃ in LiCoMnO₄ matrix endows highly reversible lithiation/delithiation process. Li₂MnO₃ can provide a high discharge capacity of over 200 mAh g⁻¹ after a high voltage (>4.5 V vs. Li⁺/Li) activation process. Such a high specific capacity of 152 mAh g⁻¹ and a high average discharge voltage of 4.8 V at a current of 100 mA g⁻¹ enable the LiCoMnO₄ to deliver a high energy density with 720 Wh kg⁻¹, which is significantly higher than any conventional high voltage cathodes, e.g., LiNi_{0.5}Mn_{1.5}O₄ (576 Wh kg⁻¹) and LiCoPO₄ (554 Wh kg⁻¹), as well as commercial cathodes LiCoO₂ (638 Wh kg⁻¹), and Ni-rich LiNi_{0.6}Co_{0.2}Mn_{0.2}O₂ (686 Wh kg⁻¹, NMC622) (FIG. 6B).

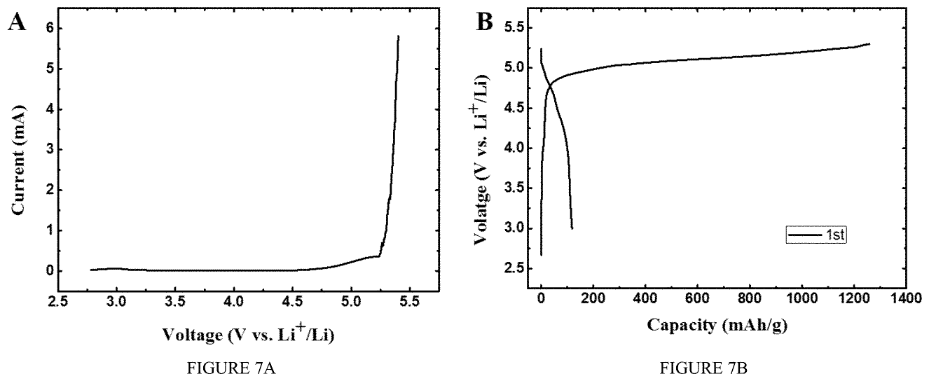

The electrochemical behavior of LiCoMnO₄ in conventional carbonate electrolyte (1M LiPF₆ in EC/DMC) was also evaluated using galvanostatic charge/discharge and linear sweep voltammogram (LSV). FIG. 7A is a graph showing linear sweep voltammograms of LiCoMnO₄ in 1 M LiPF₆ EC/DMC electrolytes with a scanning rate of 0.3 mV s⁻¹. FIG. 7B is a graph of first galvanostatic charge-discharge profile of the LiCoMnO₄ at the current rate of 0.1 A g⁻¹ (calculated based on the activated material) between 3-5.3 V. As shown in FIG. 7A, LiCoMnO₄ can be only partially lithiated/delithiated because the conventional carbonate electrolyte is oxidized significantly before the Li ion extraction from the LiCoMnO₄ structure, as demonstrated by a long electrolyte oxidation plateau (1300 mAh/g) at 5.0 V and low lithiation capacity of <100 mAh/g in galvanostatic charge/discharge curve (FIG. 7B). The incomplete lithiation/delithiation of LiCoMnO₄ in carbonate electrolytes prevent the application of LiCoMnO₄ cathode and characterization to understand the lithiation/delithiation mechanism of LiCoMnO₄.

As can be readily seen, the conventional EC/DMC electrolyte was readily oxidized when the potential increased to 5.0 V (FIG. 7A). The charge/discharge profile also confirmed that during the charge progress, there was long plateau from 4.8 to 5.3 V which correspond to the oxidization of electrolyte, and the coulombic efficiency was lower than 10% (FIG. 7B). These results show the conventional electrolyte based on EC/DMC solvent is unsuitable for high-density rechargeable batteries.

Again without being bound by any theory, it is believed that the substantially complete lithiation/delithiatiomn of LiCoMnO₄ of the present invention can be attributed to formation a robust cathodic electrolyte interphase (CEI) on LiCoMnO₄ cathodes. The composition of CEI formed by oxidation of the electrolyte solution of the present invention (e.g., 1M LiPF₆+0.02M LiDFOB in FEC/FDEC/HFE) at a high potential was also investigated. The composition of CEI on LiCoMnO₄ electrode in the electrolyte solution of the present invention was characterized using X-ray photoelectron spectroscopy (XPS). According to the atomic concentration (at. %) of elements of the CEI composition on cycled LiCoMnO₄ electrode, the major elements are carbon (C) 52.97% fluorine (F) 22.34%, and oxygen (O) 18.96%. In the C is XPS spectra, the C—O—C bind (286.3 eV) and —CO₂ bind (289.2 eV) indicate the presence of C—O compounds. This is probably due to the decomposition of the oxalate moiety in LiDFOB, which leads to the formation of CEI components. In addition, in the B is XPS spectra, the peak at 129.8 eV can be attributed to boron bonded to fluorine (B—F), which also confirms that compounds with B—F moiety from decomposition of LiDFOB additive are part of CEI components on the surface of cycled LiCoMnO₄ electrode. Moreover, the F 1s XPS spectra also exhibit a peak at 685.0 eV corresponding to Li—F bind, this component of CEI may be attributed to the decomposition of LiDFOB and fluorinated solvent. The peak with a much higher concentration at 687.8 eV can be attributed to C—F from the binder PVDF. According to the XPS results, the CEI on the surface of cycled LiCoMnO₄ electrode in the electrolyte solution of the present invention comprising LiDFOB additives has a very complicated composition. It appears to be stable and a good electric insulator, thereby blocking electron leakage through the CEI layer, which can prevent further electrolyte decomposition. This enables a great cycle stability and high CE performance in LiCoMnO₄ electrode.

The evolution of bonding and valence of transition metal ions in LiCoMnO₄ at different lithiation/delithiation stage marked in FIG. 6C was analyzed using ex-situ XAS that includes both X-ray absorption near edge structure (XANES) and extended X-ray absorption fine structure (EXAFS). The XANES data in FIG. 6D shows that as Li ions are extracted during the charge progress (regions a-d), the Co K-edge XANES spectra continuously shift toward a higher energy, indicating the increase of the oxidation state of Co. While in the discharge progress (regions e-g), the Co K-edge XANES spectra shift back to the pristine energy state, indicating the reversible reduction of Co in the structure. In contrast, the Mn K-edge XANES spectra do not show any shift during the whole charge/discharge process (regions a-g, FIG. 6E), which indicates that Mn does not change its valence state. The above XANES spectra of Co and Mn K-edge confirm that the voltage plateau in the lithiation/delithiation of LiCoMnO₄ is only attributed to the Co³⁺/Co⁴⁺. For the Fourier transform of k³-weighted EXAFS patterns in FIGS. 6F and 6G, the main peaks located at ˜1.5 and ˜2.4 Å are associated with metal-oxygen interaction in the first coordination shell and metal-metal interaction in the second coordination shell, respectively. The peak positions differ from real bond length by around 0.4 Å because of phase shift. During the whole charge/discharge progress, the position of Co—O peak changes slightly, indicating the moderate bond length change despite the oxidization/reduction of Co. This is probably due to the small size difference between Co³⁺ (0.545 Å) and Co⁴⁺ (0.53 Å). It is known that the intensity of peak for the FT EXAFS spectra is determined by two factors: the coordination number and the degree of disorder around the central atom. The intensities of Co—Co/Mn and Mn—Mn/Co peak are reduced during the high voltage regions (a-d), suggesting the significant local structural distortion (more disorder) upon the oxidization of Co³⁺ ions. During the discharging process (e-g), both the intensities of Co—Co/Mn and Mn—Mn/Co peaks increase back to almost the original state, which indicates that the structure is reversibly returned. These EXANES and EXAFS spectra data confirm the high reversibility of the LiCoMnO₄ during the charging/discharging processes.

The dynamic evolution of phase and structure of LiCoMnO₄ of the present invention during the lithiation/delithiation progress was monitored by operando XRD measurement. FIG. 8 shows the selected regions of in situ XRD patterns collected during the charge/discharge cycle. Overall, all Bragg peaks exhibit continuous shift during the entire charge/discharge process, indicating the contraction and expansion of the unit cells of the cubic phase during lithium extraction/insertion. It can be clearly seen that the lithium extraction and reinsertion occur via a solid-solution mechanism with only one phase over the whole voltage range. Such reaction mechanism is different from that in other spinel systems like LiMn₂O₄ and LiNi_{0.5}Mn_{1.5}O₄ which go through the two-phase reaction. This can be understood by the size difference between various valent cations. For Mn, changing from Mn³⁺ (0.645 Å) to Mn⁴⁺ (0.53 Å) would induce a cation size change of 0.115 Å; for Ni, changing from Ni³⁺ (0.56 Å) to Ni⁴⁺ (0.48 Å) would induce a size change of 0.08 Å. In contrast, oxidizing Co from Co³⁺ (0.545 Å) to Co⁴⁺ (0.53 Å) would only induce a size change of 0.015 Å. Such a small change greatly favors the formation of solid-solution against phase separation as the latter normally occurs when two phases have fairly different lattice parameters (caused by different cation sizes). Such solid-solution reaction mechanism is beneficial for the rate capability of this material.

Electrochemical Performance of 5.3V Li LiCoMnO₄ Full Cell:

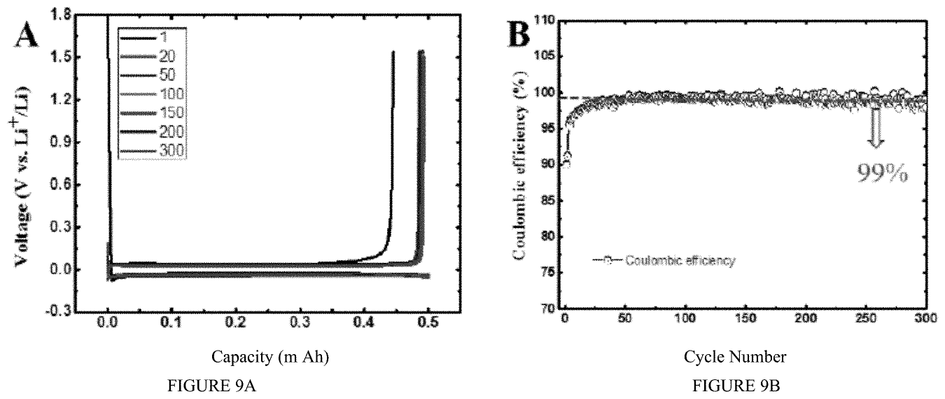

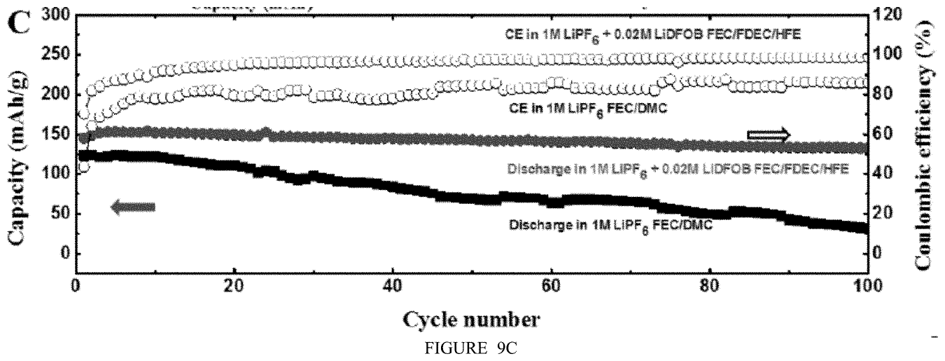

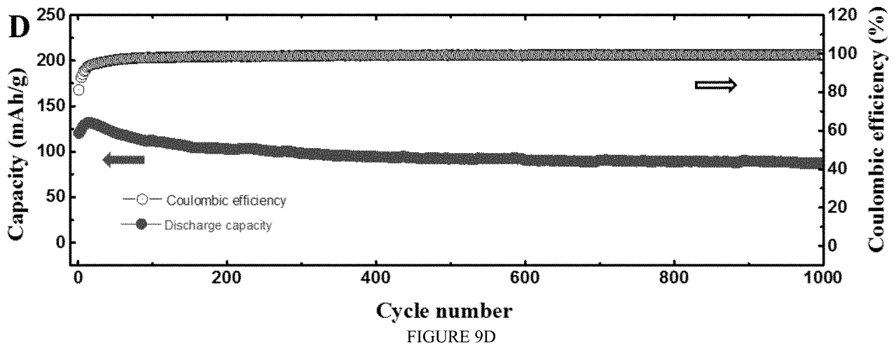

The electrochemical performance of Li metal anode in the electrolyte solution of the present invention (e.g., 1M LiPF₆+0.02M LiDFOB in FEC/FDEC/HFE) was evaluated before testing Li∥LiCoMnO₄ full cell. The reversibility of Li metal plating/stripping in the all fluorinated electrolyte was measured using Li∥Cu half-cell. The voltage profiles of Li metal plating/stripping on a Cu current collector showed a small over-potential of about 60 mV and long cycling stability at a current density of 0.5 mA cm⁻² (FIG. 9A). The Coulombic efficiency (CE) for plating/stripping reached >99% (FIG. 9B), which is substantially higher than that in the conventional electrolyte solution (˜80%). The high CE of Li plating/stripping in the electrolyte solutions of the invention is believed to be due to the formation of LiF-rich SEI.

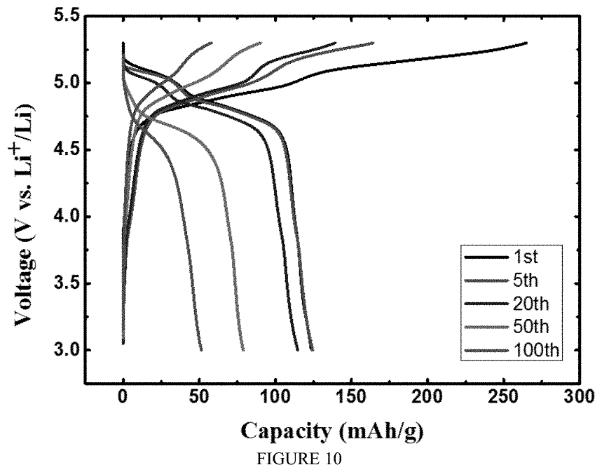

The cycling performance of the Li∥LiCoMnO₄ full cell in an electrolyte solution of the present invention (e.g., 1 M LiPF₆+0.02M LiDFOB in FEC/FDEC/HFE) was compared with the Li∥LiCoMnO₄ cell in FEC based electrolyte (1 M LiPF₆ in FEC/DMC) at a current rate of 0.1 A g⁻¹. FEC electrolyte (1 M LiPF₆ in FEC/DMC) has been considered as one of the best electrolytes for high voltage cathodes, and has been used for the Li∥LiNi_{0.5}Mn_{1.5}O₄ cell (4.7V) and Li∥LiCoPO₄ cell (4.8V). Therefore, the FEC electrolyte was selected as a control electrolyte for 5.3V Li∥LiCoMnO₄ cells. As shown in FIG. 9C, the first discharge capacity of LiCoMnO₄ at 0.1 A g⁻¹ in the FEC based electrolyte is only about 123 mAh g⁻¹ and quickly decays to less than 50 mAh/g after 100 charge/discharge cycles (FIGS. 9C and 10), while the first discharge capacity of LiCoMnO₄ in the all fluorinated electrolyte can reach 145 mAh g⁻¹ and retain 92% of the initial capacity after 100 charge/discharge cycles at the same current of 0.1 A g⁻¹. Extended cycle stability at a high current of 1 A g⁻¹ shows that the Li∥LiCoMnO₄ cell in an electrolyte solution of the present invention can retain about 80% of its initial capacity after 1000 cycles (FIG. 9D). Such a long cycle life has never been reported for >5 V batteries before. The CE of Li∥LiCoMnO₄ in the first cycle is 76% and increases to 99% after 20 cycles (FIG. 9C). In a sharp contrast, the initial CE of the Li∥LiCoMnO₄ cell in FEC/DMC electrolyte is only 46%, and remains below 85% over the entire 100 cycles. Without being bound by any theory, the low cycling CE of Li∥LiCoMnO₄ in the FEC/DMC electrolyte demonstrate that 1 M LiPF₆ in FEC/DMC cannot form a robust SEI/CEI on Li anode and LiCoMnO₄. The continuous decomposition of LiPF₆-FEC/DMC on low-potential Li metal anode and high-potential LiCoMnO₄ increases the interphase resistance, resulting in quick capacity decay of the Li∥LiCoMnO₄ cell in the charge/discharge cycles. The transmission electron microscope (TEM) and electrochemical impedance spectroscopy (EIS) of the LiCoMnO₄ electrode after 100 cycles confirm that the CEI formed in an electrolyte solution of the present invention is significantly thinner and less resistive than that formed in FEC/DMC electrolytes.

The cycle performance of Li∥LiCoMnO₄ cell in an electrolyte solution of the present invention (e.g., 1 M LiPF₆ in FEC/FEMC/HFE) was compared with different amount of LiDFOB additives (0 M, 0.02 M, 0.05 M). It was found that the specific capacity of Li∥LiCoMnO₄ cell increased with the additives, while the highest cycle stability was achieved in an electrolyte solution of the present invention with 0.02 M LiDFOB additives. Furthermore, the Li∥LiCoMnO₄ cell also delivered a high rate performance, retaining a capacity of 80 mAh g⁻¹ at a high rate of 2 A g⁻¹ (about 25 C rate calculating based on the real test time). It is believed that the high rate capability of Li∥LiCoMnO₄ cell is due to the three-dimensional ion diffusion pathways in LiCoMnO₄ and the nano-size of primary LiCoMnO₄ particle.

Electrochemical Performance of 5.3 V Graphite LiCoMnO₄ Cell:

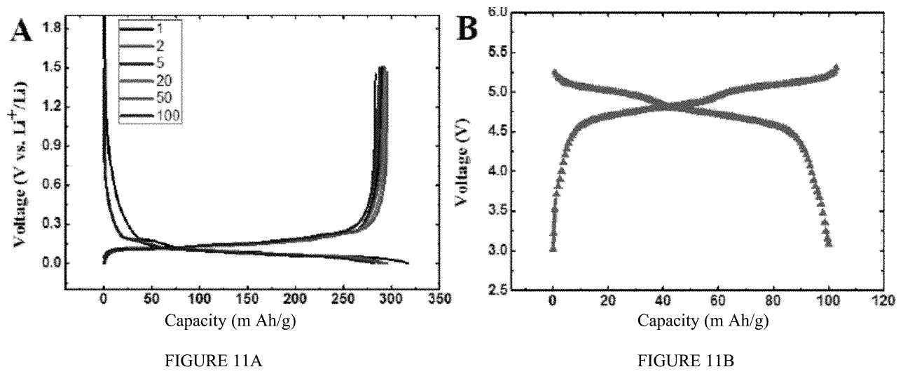

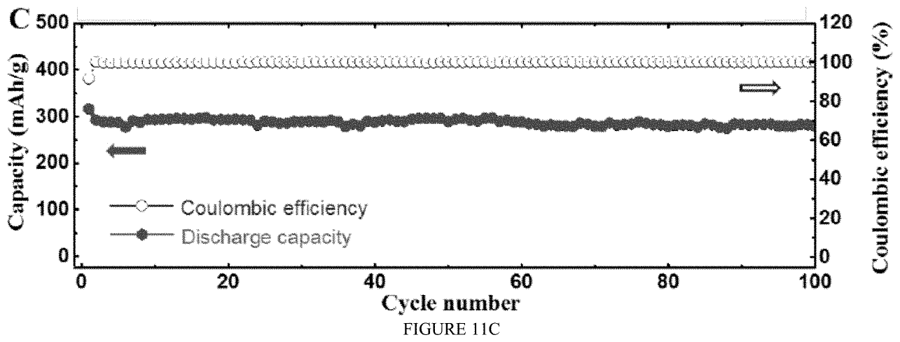

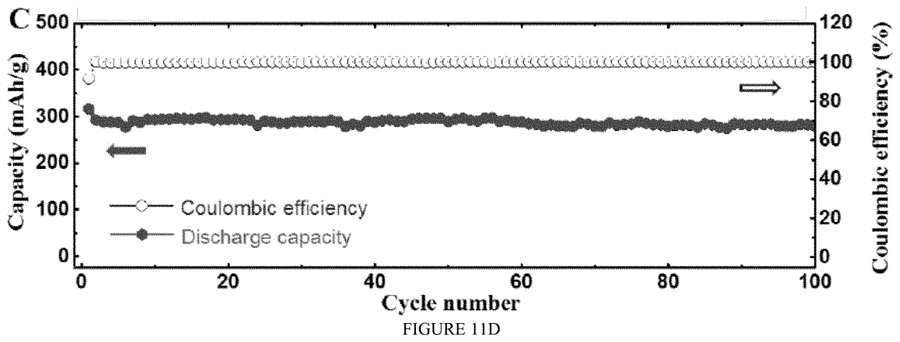

FIG. 11A shows the galvanostatic charge-discharge profiles of the graphite at different cycles in an electrolyte solution of the present invention. Graphite delivers about 300 mAh g⁻¹ reversible capacity at a current density of 0.1 A g⁻¹ with nearly 100% CE after two cycles. Furthermore, there is almost no capacity fading over 100 cycles (FIG. 11C), and able to retain 90% over 300 cycles. The high voltage electrolyte solution of the present invention also shows high stability to graphite anode in addition to Li metal anodes, which is totally different from other high voltage electrolytes, such as sulfone and organic nitriles electrolytes. In an electrolyte solution of the present invention, it is believed that the FEC and LiDFOB can form LiF-rich SEI, which is confirmed by the XPS analysis. The LiF content in SEI layer is as high as ˜70%. The extreme low electronic conductivity of LiF significantly increases the stability of SEI, enhances CE and cycle stability. Moreover, the graphite also showed a good rate performance in electrolyte solutions of the present invention.

Graphite∥LiCoMnO₄ full cell was fabricated at the weight ratio of graphite/LiCoMnO₄ as 1:2 based on the specific capacity of graphite and LiCoMnO₄ (300 and 152 mAh g⁻¹, respectively). The galvanostatic charge/discharge profiles of the graphite∥LiCoMnO₄ full cell at the rate of 1 C show two slope high voltage plateaus, from 4.9 to 5.3 V and 4.6 to 4.8 V, which provides a specific capacity of 100 mAh g⁻¹ based on both the cathode and anode active materials (FIG. 11B). The high operation voltage and high capacity of graphite∥LiCoMnO₄ full cell ensure a high energy density of 480 Wh kg⁻¹ with an excellent cycle stability of 90% capacity retention after 100 cycles (FIG. 11D). Compared with other battery chemistries, especially the Ni-rich cathode, the state-of-the-art cathode material for EV, LiCoMnO₄ possesses better thermal stability because of the stable spinel structure. In addition, electrolyte solutions of the present invention are non-flammable. Therefore, graphite∥LiCoMnO₄ and Li∥LiCoMnO₄ cells provided here are much safer than other Ni-based lithium battery systems. Moreover, the batteries with a higher operation voltage tend to have a higher power capability, enabling it more suitable for electric vehicles.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter. All references cited herein are incorporated by reference in their entirety.

What is claimed is:

1. A high-energy density rechargeable lithium battery having a cell of at least 5 V, said lithium battery comprising:
a. a high potential cathode;
b. an anode; and
c. a fluorinated electrolyte solution comprising a fluoride-based additive, wherein said fluorinated electrolyte solution is stable to at least about 5 V.

2. The high-energy density rechargeable lithium battery according to claim 1, wherein said high potential cathode comprises LiCoMnO₄, LiCoPO₄F, LiCu_{0.5}Mn_{1.5}O₄, LiNi_{0.5}Mn_{1.5}O₄, LiFe_{0.5}Mn_{1.5}O₄, LiCOPO₄, or a mixture thereof.

3. The high-energy density rechargeable lithium battery according to claim 2, wherein LiCoMnO₄ is a spinel structured LiCoMnO₄.

4. The high-energy density rechargeable lithium battery according to claim 1, wherein said anode comprises lithium metal, graphite, silicon, Li₄Ti₅O₁₂, or a combination thereof.

5. The high-energy density rechargeable lithium battery according to claim 1, wherein said lithium battery has capacity retention of at least 80% for over 1,0000 cycles.

6. The high-energy density rechargeable lithium battery according to claim 1, wherein said lithium battery has coulombic efficiency of at least coulombic efficiency of at least 99%.

7. The high-energy density rechargeable lithium battery according to claim 1, wherein said lithium battery has energy density of at least 450 Wh kg⁻¹.

8. The high-energy density rechargeable lithium battery according to claim 1, wherein said fluoride-based additive comprises lithium difluoro(oxalate)borate (LiDFOB), lithium bis(oxalato)borate, 1,3,2-dioxathiolane 2,2-dioxide, or a combination thereof.

9. The high-energy density rechargeable lithium battery according to claim 1, wherein said fluorinated electrolyte solution comprises LiPF₆ in a fluorinated solvent, wherein said fluorinated solvent comprises fluoroethylene carbonate (FEC), bis(2,2,2-trifluoroethyl) carbonate (FDEC), hydrofluoroether (HFE), 3,3,3-fluoroethylmethyl carbonate (FEMC); trifluoropropylene carbonate (TFPC); 3-Fluoropropyl hexafluoroisopropyl carbonate; tert-Butyl 3,3,3-trifluoro-2,2-dimethylpropyl carbonate; Bis(3,3,3-trifluoro-2,2-dimethylpropyl) carbonate; Isopropyl 3,3,3-trifluoro-2,2-dimethylpropyl carbonate; sec-Butyl 3,3,3-trifluoro-2,2-dimethylpropyl carbonate; Butyl 3,3,3-trifluoro-2,2-dimethylpropyl carbonate; Propyl 3,3,3-trifluoro-2,2-dimethylpropyl carbonate; Ethyl 3,3,3-trifluoro-2,2-dimethylpropyl carbonate; Methyl 3,3,3-trifluoro-2,2-dimethylpropyl carbonate; 3-Fluoropropyl 2,2,2-trifluoroethyl carbonate; 2,2-Difluoroethyl 3-fluoropropyl carbonate, or a mixture thereof.

10. The high-energy density rechargeable lithium battery according to claim 9, wherein said fluorinated solvent comprises a mixture of fluoroethylene carbonate, bis(2,2,2-trifluoroethyl) carbonate, and hydrofluoroether (FEC/FDEC/HFE).

11. The high-energy density rechargeable lithium battery according to claim 1, wherein the capacity retention of said battery at least about 80% over 100 cycles.

12. An electrolyte solution for a rechargeable lithium battery, said electrolyte solution comprising a fluorinated solvent, an inorganic fluoride salt electrolyte, and an electrolyte additive comprising lithium difluoro(oxalate)borate (LiDFOB), lithium bis(oxalato)borate, 1,3,2-dioxathiolane 2,2-dioxide, or a combination thereof.

13. The electrolyte solution of claim 12, wherein said fluorinated solvent comprises fluoroethylene carbonate (FEC), bis(2,2,2-trifluoroethyl) carbonate (FDEC), hydrofluoroether (HFE), 3,3,3-fluoroethylmethyl carbonate (FEMC); trifluoropropylene carbonate (TFPC); 3-Fluoropropyl hexafluoroisopropyl carbonate; tert-Butyl 3,3,3-trifluoro-2,2-dimethylpropyl carbonate; Bis(3,3,3-trifluoro-2,2-dimethylpropyl) carbonate; Isopropyl 3,3,3-trifluoro-2,2-dimethylpropyl carbonate; sec-Butyl 3,3,3-trifluoro-2,2-dimethylpropyl carbonate; Butyl 3,3,3-trifluoro-2,2-dimethylpropyl carbonate; Propyl 3,3,3-trifluoro-2,2-dimethylpropyl carbonate; Ethyl 3,3,3-trifluoro-2,2-dimethylpropyl carbonate; Methyl 3,3,3-trifluoro-2,2-dimethylpropyl carbonate; 3-Fluoropropyl 2,2,2-trifluoroethyl carbonate; 2,2-Difluoroethyl 3-fluoropropyl carbonate, or a mixture thereof.

14. The electrolyte solution of claim 13, wherein said fluorinated solvent comprises a mixture of fluoroethylene carbonate, bis(2,2,2-trifluoroethyl) carbonate, and hydrofluoroether (FEC/FDEC/HFE).

15. The electrolyte solution of claim 12, wherein said inorganic fluoride salt electrolyte comprises lithium hexafluorophosphate.

16. The electrolyte solution of claim 15, wherein the concentration of lithium hexafluorophosphate in said fluorinated solvent ranges from about 0.2 M to about 2 M.

17. The electrolyte solution of claim 15, wherein the amount of LiDFOB relative to lithium hexafluorophosphate is less than 1 molar equivalent.

18. The electrolyte solution of claim 12, wherein the concentration of LiDFOB in said fluorinated solvent ranges from about 0.005 M to about 0.1 M.

19. A high-density rechargeable lithium battery comprising:
a cathode comprising LiCoMnO₄ that is substantially Mn⁺³ free;
an anode selected from the group consisting of Li metal, graphite, and a mixture thereof and
an electrolyte solution comprising a fluorinated solvent, an inorganic fluoride salt electrolyte, and an electrolyte additive comprising lithium difluoro(oxalate)borate (LiDFOB), lithium bis(oxalato)borate, 1,3,2-dioxathiolane 2,2-dioxide, or a combination thereof.

20. The high-density rechargeable lithium battery according to claim 19, wherein said fluorinated solvent comprises fluoroethylene carbonate (FEC), bis(2,2,2-trifluoroethyl) carbonate (FDEC), hydrofluoroether (HFE), 3,3,3-fluoroethylmethyl carbonate (FEMC); trifluoropropylene carbonate (TFPC); 3-Fluoropropyl hexafluoroisopropyl carbonate; tert-Butyl 3,3,3-trifluoro-2,2-dimethylpropyl carbonate; Bis(3,3,3-trifluoro-2,2-dimethylpropyl) carbonate; Isopropyl 3,3,3-trifluoro-2,2-dimethylpropyl carbonate; sec-Butyl 3,3,3-trifluoro-2,2-dimethylpropyl carbonate; Butyl 3,3,3-trifluoro-2,2-dimethylpropyl carbonate; Propyl 3,3,3-trifluoro-2,2-dimethylpropyl carbonate; Ethyl 3,3,3-trifluoro-2,2-dimethylpropyl carbonate; Methyl 3,3,3-trifluoro-2,2-dimethylpropyl carbonate; 3-Fluoropropyl 2,2,2-trifluoroethyl carbonate; 2,2-Difluoroethyl 3-fluoropropyl carbonate, or a mixture thereof.
